(19) United States
(12) Patent Application Publication
(10) Pub. No.: US 2019/0137317 A1
(43) Pub. Date: May 9, 2019

(54) Liquid Residual Amount Measurement Structure

(71) Applicant: EM-TECH. Co., Ltd., Busan (KR)

(72) Inventors: Jin Seak Kim, Gyeonggi-do (KR); Seung Joo Han, Gyeonggi-do (KR)

(21) Appl. No.: 16/180,344

(22) Filed: Nov. 5, 2018

(30) Foreign Application Priority Data
Nov. 6, 2017 (KR) 10-2017-0146952
Jan. 24, 2018 (KR) 10-2018-0008966

(51) Int. Cl. G01F 23/26; A24F 47/00; G08B 21/18

(52) U.S. Cl. CPC G01F 23/265; G08B 21/182; A24F 47/008

(57) ABSTRACT

A structure of measuring a residual amount of liquid in a cartridge using a capacitance is described. According to an embodiment, the structure includes: a cartridge configured to receive liquid containing inhalation substances vaporizable by heating; at least one capacitance provided in the cartridge; a level having a signal line electrically connected to the capacitance; a MUX configured to select a signal input from the signal line; an AD converter configured to convert a capacitance value of the signal output from the MUX into a digital value; a calibration part configured to calibrate a signal level of the digital value output from the AD converter into discriminable signal bands; and a control part configured to control the MUX to select the signal and determining the signal value output from the calibration part.

### TECHNICAL FIELD

The embodiments described herein relate to an electrical smoking device, and more particularly, to a structure capable of measuring a residual amount of liquid in a cartridge, using a capacitance.

### BACKGROUND

Inhalation of favorite substances, such as so-called smoking, can be achieved through inhalation of fine particles in the air, namely, aerosol. Conventionally, a tobacco-type cigarette has been the only means for inhaling such favorite substances, but recently, an electronic cigarette has become another means. The electronic cigarette that applies heat or ultrasonic waves to a cartridge containing inhalation substances in a liquid phase to vaporize the inhalation substances and generate fine particles is completely different from the conventional tobacco-type cigarette that generates smoke through combustion, in terms of method, and thus has a resulting advantage in that it can prevent a variety of harmful substances from being generated due to combustion.

In addition, according to the needs of the consumers preferring the tobacco-type cigarette, an electronic cigarette having a filter portion of the typical cigarette and a tobacco portion has been proposed, wherein, as inhalation substances contained in the tobacco portion are vaporized by an electronic heater, a user inhales through the filter portion having an equivalent structure as the typical cigarette. Unlike the typical cigarette having a tobacco portion filled with dried tobacco leaves, this electronic cigarette is filled with paper impregnated or attached with inhalation substances. When the electronic cigarette is fit into a holder and a heater in the holder is heated to vaporize the inhalation substances contained in the tobacco portion, the user can inhale the inhalation substances vaporized through the filter portion. The user feels like smoking a typical cigarette by inhaling the inhalation substances vaporized through the filter portion in the same mechanism as the typical smoking, while there is an advantage that combustion does not occur, as in the electronic cigarette described above.

Meanwhile, referring to FIG. 1, there can be a structure having a cartomizer containing inhalation substances in a liquid phase and a cartridge into which a tobacco is inserted, wherein a heater of the cartomizer is heated to vaporize the liquid, and the vaporized liquid is introduced into the cartridge through a path to heat a film heater provided on the periphery of the tobacco, which makes it possible to inhale the inhalation substances vaporized from the liquid and the inhalation substances vaporized from the tobacco together. However, in the case of the cartridge containing inhalation substances in a liquid phase, as the liquid is consumed in the cartridge during the smoking, the heater may be operated with little or no liquid, as a result of which the heater is overheated, power consumption increases, and the feeling and taste of the electronic cigarette are degraded, which poses issues on the safety and ease of use. Conventionally, a residual amount of liquid in the cartridge is not measured, and there is a method of cutting off power supplied to the heater, by sensing a change in resistance when a heater coil reaches a certain temperature. However, if liquid-phase inhalation substances remain on the wick of the cartridge to some extent, there is no rise in temperature, which makes it difficult to sense a change in resistance and thus to determine whether there are no inhalation substances or there are little inhalation substances not suitable for smoking.

### SUMMARY

Described herein is a structure capable of measuring a residual amount of liquid remaining in a cartridge during the use of an electronic cigarette.

According to an embodiment, there is provided a structure of measuring a residual amount of liquid in a cartridge, including: a cartridge capable of receiving liquid containing inhalation substances vaporizable by heating; at least one capacitance provided in the cartridge; a level having a signal line electrically connected to the capacitance; a MUX for selecting a signal input from the signal line; an AD converter for converting a capacitance value of the signal output from the MUX into a digital value; a calibration part for calibrating a signal level of the digital value output from the AD converter into discriminable signal bands; and a control part for controlling the MUX to select the signal and determining the signal value output from the calibration part.

In some embodiments, the control part generates a warning with an LED or vibration means when determining that the residual amount of liquid remaining in the cartridge is below an allowable value.

In some embodiments, the control part controls a battery to cut off power supplied to a coil provided at the lower portion of the cartridge when determining that the residual amount of liquid remaining in the cartridge is below an allowable value.

According to an embodiment, the structure of measuring the residual amount of liquid in the cartridge can measure a residual amount of liquid remaining in the cartridge during the use of the electronic cigarette and can cut off power supplied from the battery and generate a warning when determining that the residual amount of liquid remaining in the cartridge is below an allowable value.

Those skilled in the art will recognize additional features and advantages upon reading the following detailed description, and upon viewing the accompanying drawings.

### BRIEF DESCRIPTION OF THE DRAWINGS

FIG. 1 is a sectional view of an electrical smoking device having a liquid cartridge according to an embodiment.

FIG. 2 is an exploded view of the electrical smoking device having the liquid cartridge according to an embodiment.

FIG. 3 is an explanatory view of a structure of measuring a residual amount of liquid in the cartridge of the electrical smoking device.

FIG. 4 is a block diagram of the structure of measuring a residual amount of liquid in the cartridge according to an embodiment.

### DETAILED DESCRIPTION

A structure of measuring a residual amount of liquid in a cartridge according an embodiment includes: a cartridge capable of receiving liquid containing inhalation substances vaporizable by heating; at least one capacitance provided in the cartridge; a level having a signal line electrically connected to the capacitance; a MUX (multiplexor) for selecting a signal input from the signal line; an AD (analog-to-digital) converter for converting a capacitance value of the signal output from the MUX into a digital value; a calibration part for calibrating a signal level of the digital value output from the AD converter into discriminable signal bands; and a control part for controlling the MUX to select the signal and determining the signal value output from the calibration part.

According to an embodiment, the control part generates a warning with an LED (light emitting diode) or vibration means when determining that the residual amount of liquid remaining in the cartridge is below an allowable value.

According to an embodiment, the control part controls a battery to cut off power supplied to a coil provided at the lower portion of the cartridge when determining that the residual amount of liquid remaining in the cartridge is below an allowable value.

The structure of measuring a residual amount of liquid in a cartridge will now be described in detail with reference to the accompanying drawings.

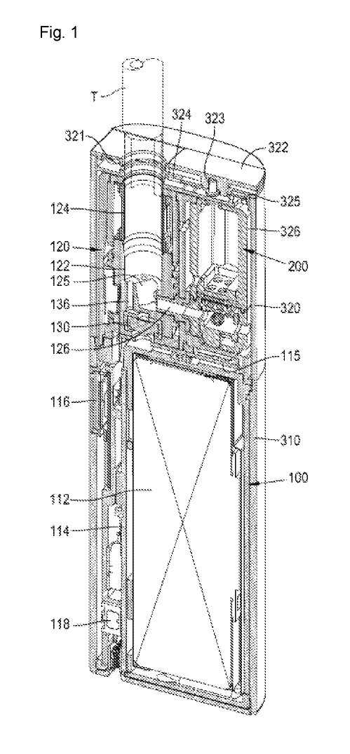

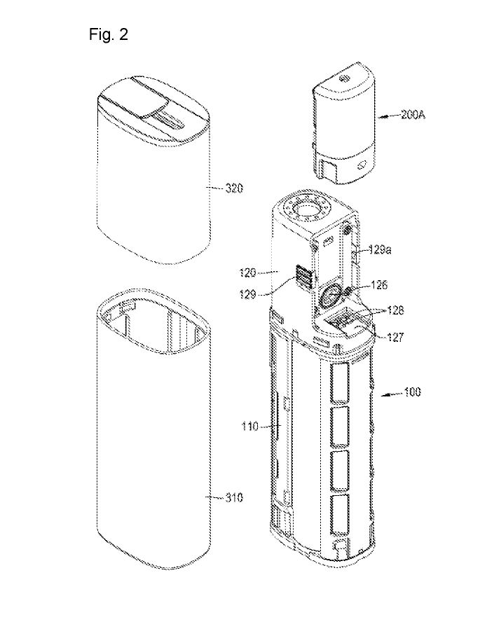

FIG. 1 is a sectional view of an electrical smoking device having a liquid cartridge according to one embodiment, and FIG. 2 is an exploded view of the electrical smoking device having the liquid cartridge according to one embodiment. The electrical smoking device having the liquid cartridge according to one embodiment includes a main body 100 and a liquid cartridge assembly 200A attachable and detachable to/from the main body 100, upper and lower casings 310 and 320 covering the main body 100 and the liquid cartridge assembly 200A and forming the appearance.

Components such as a battery 112, a main circuit board 114, a button 116, etc. are disposed at the lower portion 110 of the main body 100, while a smoking portion 120 for the use of smoking a tobacco T is disposed at the upper portion thereof. The size of the smoking portion 120 is smaller than the size of the lower portion 110 of the main body, which allows an extra space on one side. The liquid cartridge assembly 200A is coupled to this space.

The smoking portion 120 includes a cylindrical receiving portion 122 with an open top end, so that the tobacco T can be inserted thereinto, and a cylindrical heater 124 disposed on the inner circumference of the receiving portion 122 to heat the tobacco T. The heater 124 is connected to and controlled by the main circuit board 114 and supplied and heated with power from the battery 112 through an input of the button 116. The heater 124 formed in a cylindrical shape to surround the tobacco T generates less wastes of tobacco leaves after smoking than the heater inserted into the tobacco T. In addition, the cylindrical shape is advantageous to form an airflow path on the lower side of the tobacco T in terms of space.

Meanwhile, the upper casing 320 includes a hole 321 corresponding to the position of the receiving portion 122 and a slide cover 322 capable of opening and closing the hole 321 and the receiving portion 122. A single flange roller 343 is coupled to the lower portion of the slide cover 322, and a slit 324 along which the single flange roller 343 moves is formed in the upper casing 320. Further, the upper casing 320 has an extra space 326 between the liquid cartridge assembly 200A and the upper casing 320 to allow the fresh air to move to the liquid cartridge assembly 200A and also has a vent 325 through which the fresh air is introduced into the extra space 326.

Moreover, the structure further includes a vibration motor 118 connected to the main circuit board 114, the vibration motor 118 being operated to inform a user that he/she can smoke when the heater 124 is heated to a smoking temperature.

Also, an auxiliary circuit board 115 connected to the main circuit board 114 to transmit a control signal to the liquid cartridge assembly 200A is disposed on the top surface of the lower portion 110, and a spring terminal 128 is connected to the upper portion of the auxiliary circuit board 115. A terminal (not shown) of the liquid cartridge assembly 200A is brought into contact with the spring terminal 128 connected to the auxiliary circuit board 115 so that power and electrical signals can be supplied to a coil 270 provided on the bottom surface of the liquid cartridge assembly 200A and electrically connected to the terminal. Further, a pressure sensitive sensor 130 is connected to the auxiliary circuit board 115, and a pressure sensitive path 136 is provided that allows the pressure sensitive sensor 130 and the receiving portion 122 to communicate with each other. When the user inhales the tobacco T, the pressure sensitive sensor 130 can sense a negative pressure through the pressure sensitive path 136. When the pressure sensitive sensor 130 senses the negative pressure, the auxiliary circuit board 115 can apply an electrical signal to the liquid cartridge assembly 200A to atomize liquid.

Additionally, the structure further includes atomizing liquid paths 126 and 125 formed separately from the pressure sensitive path 136 and connected to the receiving portion 122. The atomizing liquid paths 126 and 125 are connected to an atomizing liquid path 366 of the liquid cartridge assembly 200A.

In one embodiment, the auxiliary circuit board 115 is further provided to control the liquid cartridge assembly 200A, but it should be recognized that the auxiliary circuit board 115 can be omitted and the main circuit board 114 can control all the components.

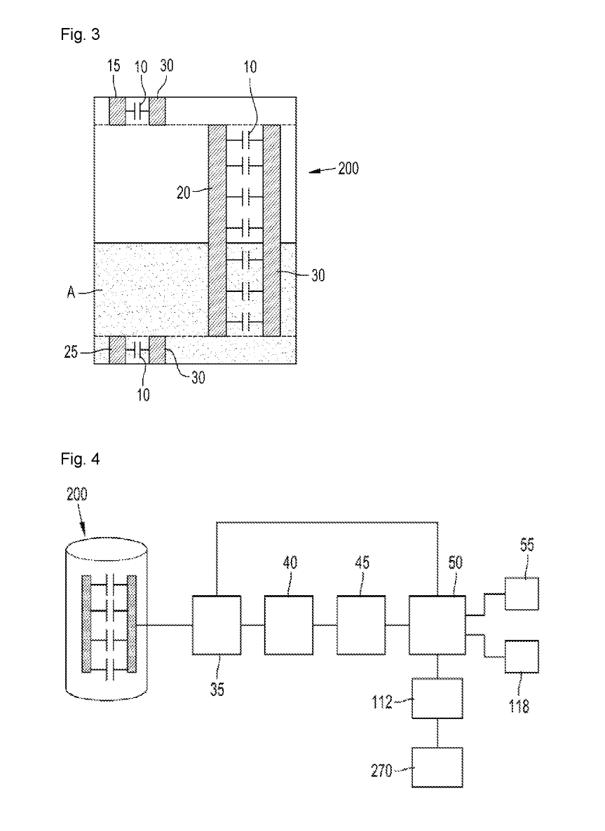

FIG. 3 is an explanatory view of the liquid cartridge 200 of the electrical smoking device. Referring to FIG. 3, a plurality of capacitances 10 are provided in the liquid cartridge 200 of the electrical smoking device to measure a residual amount of liquid. More specifically, at the upper portion of the liquid cartridge 200, the capacitance 10 is connected to a top level 15, and then connected to a MUX 35 discussed later through a signal line provided on the top level 15. When liquid A remains in the liquid cartridge 200 up to the top level 15, the capacitance 10 connected to the top level 15 has a preset value indicating that a maximum amount of liquid A remains in the liquid cartridge 200. When liquid A remains below the top level 15, the capacitance 10 connected to the top level 15 has a variable value indicating liquid A remaining below the top level 15.

The capacitance 10 is connected to a shield pattern 30 to prevent a possible short. In addition, at the lower portion of the liquid cartridge 200, the capacitance 10 is connected to a bottom level 25, and then connected to a MUX 35 discussed later through a signal line provided on the bottom level 25. When liquid A remains in the liquid cartridge 200 above the bottom level 25, the capacitance 10 connected to the bottom level 25 has a preset value indicating that liquid A remains in the liquid cartridge 200 above the bottom level 25. When liquid A remains below the bottom level 25, the capacitance 10 connected to the bottom level 25 has a variable value indicating liquid A remaining below the bottom level 25, as a result of which it can be seen that liquid A rarely remains in the liquid cartridge 200. The capacitance 10 is connected to a shield pattern 30 to prevent a possible short. Also, the plurality of capacitances 10 are provided between the top level 15 and the bottom level 25, connected to an intermediate level 20 and a shield pattern 30, respectively, and connected to a MUX 35 discussed later through a signal line provided on the intermediate level 20, respectively. Depending on which capacitance 10 liquid A in the liquid cartridge 200 contacts, the value of each capacitance 10 changes.

FIG. 4 is a block diagram of the structure of measuring a residual amount of liquid in the cartridge according to one embodiment. Referring to FIG. 4, each of the capacitances 10 is connected to the MUX 35 through the signal line provided on the top level 15, the bottom level 25, and the intermediate level 20. A control part 50 controls the MUX 35 to select the signal line connected to the capacitance 10. A capacitance value of the signal line selected by the MUX 35 is converted into a digital signal value by an AD converter 40, a signal level of the converted digital signal value is calibrated into discriminable signal bands by a calibration part 45, and then the resulting signal value is input to the control part 50. The control part 50 reads changes in the signal value input through the calibration part 45 in real time and calculates a residual amount of liquid A. The changes in the value of the capacitance 10 over the usage time and thus the residual amounts of liquid A may be previously input and set in the control part 50. Therefore, when an amount excessively larger or smaller than the previously-input changes in the value of the capacitance 10 corresponding to the usage time is input, the control part 50 determines that there must have been a malfunction in the measurement of the residual amount of liquid, deems the signal value as noise, and reserve judgment. Further, when the residual amount of liquid A is below an allowable value and the value of the capacitance 10 at the bottom level 25 is changed, the control part 50 controls the battery 112 to cut off power supplied to the coil 270 provided at the lower portion of the liquid cartridge 200 to light the LED 55 or operate the vibration motor 118 to generate a warning.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

### EXPLANATION OF REFERENCE NUMERALS FOR MAJOR PORTIONS SHOWN IN DRAWINGS

100: Main body

200: Liquid cartridge

10: Capacitance

15: Top level

20: Intermediate level

25: Bottom level

30: Shield pattern

35: MUX

40: AD converter

45: Calibration part

50: Control part

55: LED

110: Lower portion of main body

112: Battery

114: Main circuit board

115: Auxiliary circuit board

116: Button

118: Vibration motor

120: Smoking portion

122: Receiving portion

124: Heater

125, 126: Atomizing liquid path

128: Spring terminal

130: Pressure sensitive sensor

136: Pressure sensitive path

200A: Liquid cartridge assembly

270: Coil

310: Upper casing

320: Lower casing

321: Hole

322: Slide cover

324: Slit

325: Vent

326: Extra space

343: Single flange roller

366: Atomizing liquid path

T: Tobacco

A: Liquid

What is claimed is:

1. A structure of measuring a residual amount of liquid in a cartridge, the structure comprising:
a cartridge configured to receive liquid containing inhalation substances vaporizable by heating;
at least one capacitance provided in the cartridge;
a level having a signal line electrically connected to the capacitance;
a MUX configured to select a signal input from the signal line;
an AD converter configured to convert a capacitance value of the signal output from the MUX into a digital value;
a calibration part configured to calibrate a signal level of the digital value output from the AD converter into discriminable signal bands; and
a control part configured to control the MUX to select the signal and determine the signal value output from the calibration part.

2. The structure of claim 1, wherein the level comprises a top level connected to a first capacitance provided at the top portion of the cartridge, a bottom level connected to a second capacitance provided at the bottom portion of the cartridge, and an intermediate level connected to at least one third capacitance provided between the first capacitance provided at the top portion and the second capacitance provided at the bottom portion.

3. The structure of claim 2, further comprising a shield pattern connected to the capacitance.

4. The structure of claim 2, wherein the control part is configured to generate a warning with an LED or vibration means when determining that the residual amount of liquid remaining in the cartridge is below an allowable value.

5. The structure of claim 2, wherein the control part is configured to control a battery to cut off power supplied to a coil provided at a lower portion of the cartridge when determining that the residual amount of liquid remaining in the cartridge is below an allowable value.

6. The structure of claim 1, further comprising a shield pattern connected to the capacitance.

7. The structure of claim 1, wherein the control part is configured to generate a warning with an LED or vibration means when determining that the residual amount of liquid remaining in the cartridge is below an allowable value.

8. The structure of claim 1, wherein the control part is configured to control a battery to cut off power supplied to a coil provided at a lower portion of the cartridge when determining that the residual amount of liquid remaining in the cartridge is below an allowable value.
